(19) United States
(12) Patent Application Publication
(10) Pub. No.: US 2008/0042846 A1
(43) Pub. Date: Feb. 21, 2008

(54) Antenna for radio frequency identification systems

(75) Inventors: Alan Peter Jenkins, Groton, MA (US); Frederic Carrez, Lexington, MA (US); Jean Pierre Lanteri, Waltham, MA (US); Timothy Joseph Relihan, Lake Worth, FL (US); Gary Mark Shafer, Boca Raton, FL (US)

Correspondence Address: Brian C. Oakes;Tyco Electronics, Suite 140, 4550 New Linden Hill Road, Wilmington, DE, 19808-2952, US

(73) Assignees: M/A-Com, Inc.; Sensormatic Electronics Corporation

(21) Appl. No.: 11/500,817

(22) Filed: Aug. 8, 2006

(51) Int. Cl. G08B 13/14

(52) U.S. Cl. 340/572.7

(57) ABSTRACT

An antenna for a radio frequency identification (RFID) system and a method for communicating in an RFID system are provided. The antenna includes a first port configured to provide RFID communication in a first polarization plane and a second port configured to provide RFID communication in a second polarization plane. The first polarization plane is orthogonal to the second polarization plane.

### BACKGROUND OF THE INVENTION

This invention relates generally to wireless communication systems and, more particularly, to an antenna for radio frequency identification (RFID) systems.

Radio frequency identification (RFID) systems are increasingly used to acquire information that may be used, for example, to monitor and track products and processes. For example, RFID systems may be used to monitor the inventory of products in a retail environment. RFID systems provide automatic identification using the storage and remote retrieval of data using RFID tags or transponders. An RFID tag can be attached or integrated within a product or product packaging. These RFID tags receive and respond to radio frequency (RF) signals to provide information, for example, related to the product to which the RFID tag is attached. For example, modulators of the RFID tags may transmit back a signal using a transmitter or reflect back a signal to the RFID readers. Additionally, information may be communicated to the RFID tags (e.g., encoding information) using RFID encoders.

RFID systems include RFID readers that can detect and receive information from a large number of RFID tags at the same time. Additionally, RFID readers can transmit and receive at the same time on the same frequency with the signal power usually being much higher for the transmit signals than the receive signals. This results in architectural constraints on the design of the RF front end. Known RFID systems include processes and methods to minimize collisions and/or interference to increase the likelihood that reflected signals from RFID tags are received. For example, known RFID systems includes circulators, sometimes configured as isolators, to control transmission and reception of signals. Other known RFID systems use couplers to control transmission and reception of signals. Still other RFID systems use separate transmit and receive antennas to control transmission and reception of signals. These processes and method attempt to provide transmission and reception isolation at the antenna port. Improvement in the transmit and receive isolation can result in improved performance of the RFID readers.

These RFID readers may be fixed/stationary and/or portable (e.g., handheld RFID reader). For example, fixed RFID readers may be positioned at dock doors to read the RFID tags of products on pallets or cases that pass by the RFID readers. RFID readers also may be handheld and used, for example, by individuals walking through a retail store or business reading RFID tags of products on shelves or in a storage area. RFID readers may be used in many different applications other than product identification and tracking, including, for example, animal identification, file folder identification in an office, airline baggage tracking, building access control, electronic traffic toll collection, among many others.

Portable RFID readers have issues that are not present in fixed RFID readers due in part to size constraints. For example, because of the desire for small footprint RFID readers, the size of the components must not be large. Thus, known components for controlling the transmission and reception of signals using RFID readers may not allow for these small footprint designs. For example, circulators are large in size, thereby adding size and weight to the RFID reader. Also, circulators can be a higher cost component, thereby increasing the overall cost of the RFID reader. An alternative approach to separating the transmit and receive signals is to use couplers. However, these couplers have significant insertion loss (due to the coupling coefficient). Thus, the system must operate with a higher transmit power resulting in the use of a larger amount of power. Therefore, batteries must be larger to support operation of the couplers. This increases the size of the RFID reader. If smaller batteries are used, operating power or operating life may not be acceptable. Using separate antennas also increases the size of the RFID reader.

Thus, known RFID systems include components to control transmission and reception of signals from and to an RFID reader that increases the cost and size of the RFID readers. Some of these known components may be too large to place within a portable RFID reader. Accordingly, these known components can result in design and operating constraints and limitations.

### BRIEF DESCRIPTION OF THE INVENTION

In an exemplary embodiment, an antenna for a radio frequency identification (RFID) system is provided that includes a first port configured to provide RFID communication in a first polarization plane and a second port configured to provide RFID communication in a second polarization plane. The first polarization plane is orthogonal to the second polarization plane.

In another exemplary embodiment, a radio frequency identification (RFID) reader is provided that includes a transmitting portion configured to transmit RFID signals and a receiving portion configured to received RFID signals from at least one RFID tag. The RFID reader further includes a dual port polarized antenna configured having orthogonal polarization and configured to be connected to the transmitting portion and the receiving portion.

In yet another exemplary embodiment, a method for communicating in a radio frequency identification (RFID) system is provided. The method includes transmitting an RFID signal in a first polarization plane and receiving an RFID signal from an RFID tag in a second polarization plane. The first polarization plane is orthogonal to the second polarization plane.

### BRIEF DESCRIPTION OF THE DRAWINGS

FIG. 1 is a block diagram of an RFID system constructed in accordance with an exemplary embodiment of the invention.

FIG. 2 is a block diagram of an RFID system constructed in accordance with another exemplary embodiment of the invention.

FIG. 3 is a block diagram of an RFID system constructed in accordance with another exemplary embodiment of the invention.

FIG. 4 is a block diagram of an RFID tag constructed in accordance with an exemplary embodiment of the invention.

FIG. 5 is a block diagram of an RFID tag constructed in accordance with another exemplary embodiment of the invention.

FIG. 6 is a block diagram of an RFID reader constructed in accordance with an exemplary embodiment of the invention.

FIG. 7 is a dual port antenna for the RFID reader of FIG. 6 constructed in accordance with an exemplary embodiment of the invention.

FIG. 8 is a dual port antenna for the RFID reader of FIG. 6 constructed in accordance with another exemplary embodiment of the invention.

FIG. 9 is a dual port antenna for the RFID reader of FIG. 6 constructed in accordance with another exemplary embodiment of the invention.

### DETAILED DESCRIPTION OF THE INVENTION

Various embodiments of the invention provide for controlling communication in a radio frequency identification (RFID) system. More particularly, various embodiments of the invention provide for controlling the transmission and reception of signals from and to RFID readers of the RFID system. In general, a dual port antenna is used in connection with RFID readers to isolate transmissions and receptions.

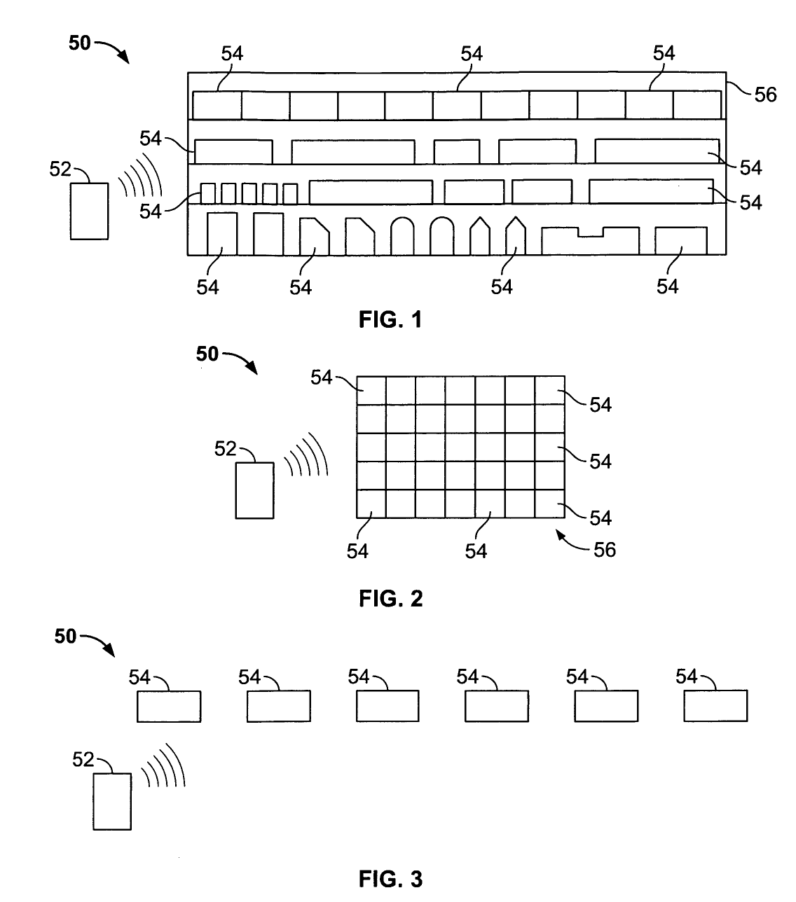

Specifically, and referring to FIGS. 1 through 3, an RFID system 50 constructed according to various embodiments of the invention generally includes an RFID communication device, such as an RFID reader 52 and a plurality of identification devices (not shown), for example, a plurality of RFID tags associated with different objects 54. The RFID communication device 52 and RFID tags communicate via radio frequency (RF) and generally operate in accordance with known RFID communication methods. For example, as shown in FIG. 1, the objects 54 are supported on a support structure 56 with each object having attached thereto or integrated therewith one or more RFID tags as is known. For example, the objects 54 may be products, such as retail products and the support structure 56 a shelf for displaying the objects 54. It should be noted that the objects may be of different size and shape. Additionally, the objects may be constructed of different materials with the RFID tag located on the outside or within the product or product packaging as is known.

As another example, as shown in FIG. 2, a plurality of objects 54 may be located within a support structure 56. For example, the plurality of objects 54 may be boxes and the support structure 56 a crate/case or similar structure for transporting the structure. The RFID reader 52 may be used to communicate with RFID tags associated with the objects 54 while the support structure 56 is stationary or in motion. As still another example, as shown in FIG. 3, the objects 54 may not be supported by a support structure and the objects 54 may be stationary or in motion. For example, the objects 54 may be luggage or vehicles having RFID tags attached therewith.

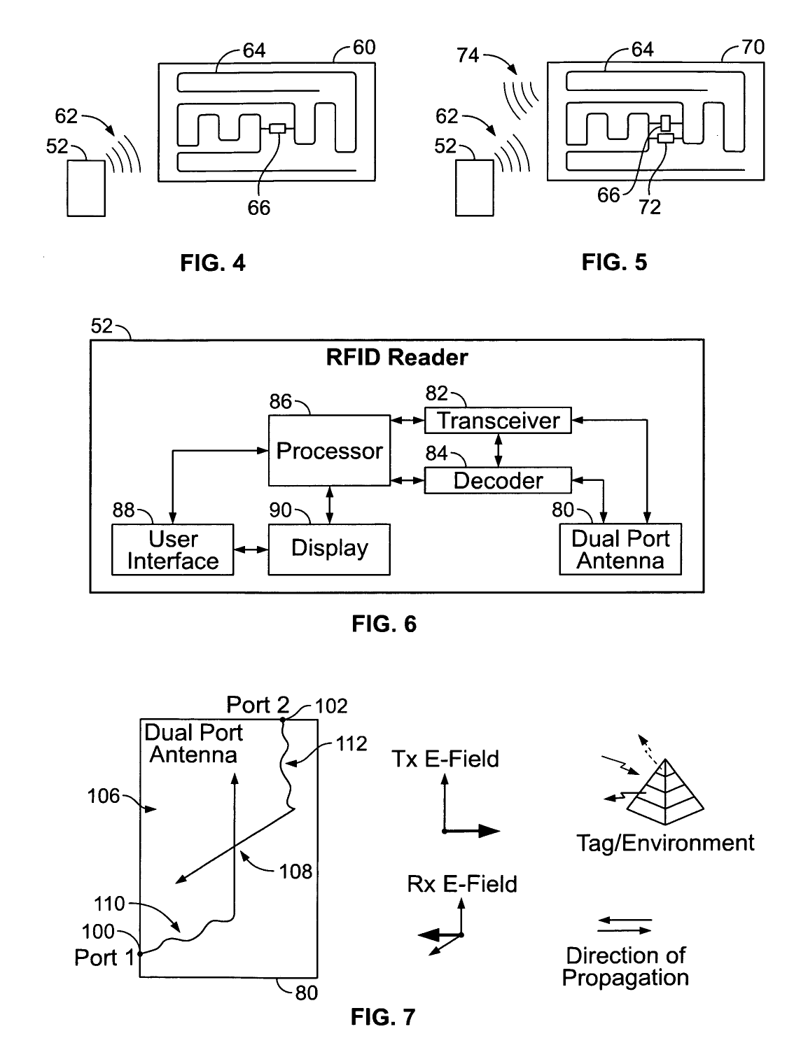

In various embodiments, the RFID tags 60 are passive radio reflective identification tags or passive RFID tags as shown in FIG. 4. The passive RFID tags 60 do not include a battery or other power source and when radio waves 62 from the RFID reader 52 or other RFID interrogator (as is known) are detected by an antenna 64 of the RFID tag 60, the energy is converted by the antenna 64 into electricity that can power up, for example, a processor, such as a microchip 66 in the RFID tag 60. The RFID tag 60 is then able to communicate, and more particularly, transmit to the RFID reader 52 information stored in the microchip 66. For example, the information transmitted may include the type of object to which the RFID tag 60 is connected, including, for example, a serial number, the time and date of the transmission, the location of the RFID tag 60 transmitting the information, etc. and which is generally referred to herein as RFID tag information.

In other various embodiments, RFID tags 70 are active radio identification tags or active RFID tags as shown in FIG. 5. The active RFID tags 70 also include a transmitter 72 to communicate, and more particularly, transmit (as opposed to reflecting back) signals 74 to the RFID reader 52 having the RFID tag information. The active RFID tags 70 use a battery (not shown) or other power source (e.g., optically powered) to transmit the signals 74 to the RFID reader 52.

It should be noted that the objects 54 shown in FIGS. 1 through 3, or other objects may include only active RFID tags, only passive RFID tags or a combination of active and passive RFID tags. A determination of which type of RFID tag to use may be based on the particular application, for example, the distance over which the RFID tags must be detected (e.g., long distance versus short distance). This may determined, for example, based on the type of products and location of the products having the RFID system implemented in connection therewith.

It should be noted that the RFID reader 52 may be a stand alone unit, for example, a portable or handheld unit or may be integrated with another communication device, such as mobile or cellular telephones, personal digital assistants (PDAs), Blackberry devices, etc. Alternatively, components within, for example, the cellular telephone, such as the transceiver, processor and/or software may be modified to provide the same functionality and operation of the RFID reader 52. Still other alternatives include a plug-in or add-on unit, such as, a plug-in module for a PDA that includes therein the RFID reader 52.

In various embodiments, as shown in FIG. 6, the RFID reader 52 includes a dual port antenna 80 connected to a transceiver 82 and a decoder 84. It should be noted that the transceiver 82 and decoder 84 may be provided as a single unit. Additionally, in an alternate embodiment, the transceiver 82 is replaced by a separate transmitter (not shown) and receiver (not shown). In general, a transmitting portion and receiving portion are provided, for example, as a transceiver 82. Further, a processor 86 is connected to the transmitter 82 and the decoder 84. A user interface 88 also is connected to the processor 86 and to a display 90.

In operation, the dual port antenna 80, which may be configured as a scanning antenna, transmits radio frequency (RF) signals, for example, RFID signals. The transceiver 82 may be configured such that the RF signals are transmitted over a determined range, for example, a short range (e.g., 5 feet or 10 feet). The RF signals, which are essentially RF radiation, allow communication with the RFID tags 60 and 70 (shown in FIGS. 4 and 5) as is known. In particular, the RF signals allow communication with the microchip 66 (shown in FIGS. 4 and 5) of the RFID tags 60 and 70. The RF radiation provides energy, and more particularly, energizes passive RFID tags, such as the RFID tag 60 to allow communication with the RFID tag 60. When the RFID tag 60 or 70 passes through an RF radiation field generated by the RF reader 52 and transmitted by the dual port antenna 80, the RFID tag 60 or 70 detects the signal (e.g., activation signal) from the RFID reader 52. The RFID tag 60 or 70 is activated, which may include energizing the RFID tag 60 or 70 and RFID tag information, for example, stored on the microchip 66 is transmitted back to the RFID reader 52. For example, the RFID tag information may be reflected back by the RFID tag 60 or may be transmitted back using the transmitter 72 (shown in FIG. 5) of the RFID tag 70.

Upon receiving the signals from the RFID tags 60 and 70 via the dual port antenna 80 using the transceiver 82, and that includes the RFID tag information, the signals are decoded in any known manner, for example, using the decoder 84. It should be noted that RFID tag information from a plurality of RFID tags 60 and/or 70 may be transmitted at the same time. The RFID tag information then may be processed using the processor 86 and the results displayed on the display 90. For example, information relating to the quantity and type of products to which the RFID tags 60 or 70 are attached may be displayed on the display 90. Further, and for example, a user may select the type of information to be displayed or provide other inputs using the user interface 88 (e.g., a keyboard). It should be noted that in various embodiments the RFID reader 52 is a portable device, for example, a handheld device provided, for example, in a scanner type configuration. In another various embodiments, the RFID reader 52 is a fixed or stationary device and configured to be attached to a support structure, for example, a wall, door frame, etc.

In various embodiments, the dual port antenna 80 is configured as shown in FIG. 7 with a first port 100 of the dual port antenna 80 connected to a transmit side of the RFID reader 52, for example, the transmitter of the transceiver 82 (shown in FIG. 6). A second port 102 of the dual port antenna 80 is connected to a receive side of the RFID reader 52, for example, the receiver of the transceiver 82. The dual port antenna 80 is configured as a dual polarized antenna. In this dual polarized configuration, and for example, a transmit signal is transmitted with a horizontal polarization through the first port 100 and the receiver side is coupled to the orthogonal (in this example vertical) polarization via the second port 102.

More particularly, the two ports 100 and 102 of the dual port antenna 80 are coupled to one of two linear orthogonal polarization planes. In operation, as shown in FIG. 7, the transmit wave propagates away from the dual port antenna 80 and interacts with RFID tag(s) and the surrounding environment. The radiated transmit wave does not directly couple with the receive radiation as a result of the cross polar isolation of the dual port antenna 80. Essentially, E-field rotation occurs and the signal in the horizontal polarization is coupled to the second port 102, and thus to the receiver. Further, the RFID tags 60 and 70 (shown in FIGS. 4 and 5) are configured such that signals from the RFID tags 60 and 70, for example, return/reflected signals are rotated in polarization. For example, the propagation environment is typically a predominately multipath type propagation that induces polarization rotation. Additionally, the antenna 64 (shown in FIGS. 4 and 5) of the RFID tags 60 and 70 may contribute to cross polarization such that RF energy is reflected into the opposite polarization plane to the plane in which the signal from the RF reader 52 was received. Different rotations of polarization are also possible.

In various embodiments, the dual port antenna 80 may be constructed utilizing a patch type structure 106 (e.g., a microstrip patch antenna) having a two-dimensional resonator 108 configured in an orthogonal arrangement. In this embodiment, a first side 110 of the two-dimensional resonator 108 is connected to the first port 100 and a second side 112 (the other orthogonal side) of the two-dimensional resonator 108 is connected to the second port 102. In this configuration, and for example, the first port 100 may be connected to a transmitter or transmitter portion of the RFID reader 52 and the second port 102 may be connected to the receiver or receiver portion of the RFID reader 52.

It should be noted that the patch type structure 106 may be constructed in any manner to form the orthogonal arrangement. For example, any type of conductor may be used and mounted, for example, on a ground plane formed from a printed circuit board. In general, any flat plate, for example, metal plate over a ground plane may be used, such as a patch structure on a dielectric loaded substrate. Further, and for example, a copper film may be bonded to a ceramic. Additionally, the various embodiments are not limited to a dual port antenna 80 configured as a patch antenna. For example, different planar and non-planar radiator structures can be used, such as a simple pair of dipole antennae positioned ninety degrees with respect to each other. Also, any kind of orthogonal polarization may be used, for example, linear polarization and circular polarization, among others.

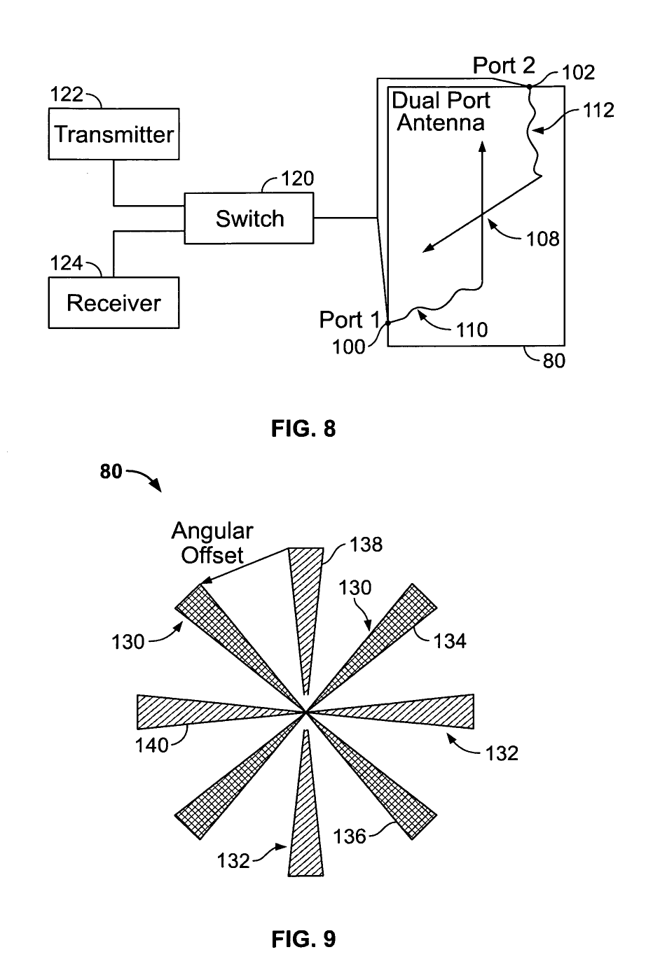

In another embodiment, as shown in FIG. 8, the dual port antenna 80 is configured as a switched dual port antenna. In particular, a switch 120 is connected to both the first port 100 and the second port 102. The switch is also connected to a transmitter 122 and a receiver 124, which may be, for example, transmitting and receiving portions of the transceiver 82 (shown in FIG. 6). The switch 120 may be any switching device capable of switching the transmitter 122 and/or receiver 124 between the first port 100 and the second port 102. Additionally, the switching components may be formed as part of the dual port antenna 80.

In operation, using the configuration shown in FIG. 8, the dual port antenna 80 allows both horizontal and vertical polarization orientation of the transmit signal waveform transmitted from the transmitter 122. It should be noted that the receiver 124 is connected to the orthogonal port. In various embodiments, the switching of the ports using the switch 120 may be multiplexed in time between the transmit signal output and the receive signal input. For example, the switch 120 may switch the transmitter 122 and a receiver 124 between the first port 100 and the second port 102 such that half of the time the transmitter 122 is connected to the first port 100 and half of the time the transmitter 122 is connected to the second port 102 (with the receiver 124 connected to the other port). However, it should be noted that other switching cycles or duty cycles other than fifty percent may be provided. For example, based on the system, environment and/or RFID tags, the transmitter 122 and/or receiver 124 may be switched to one of the first port 100 or second port 102 for more than half the time.

Other variations of antenna configurations are also possible. For example, in another embodiment of the dual port antenna 80 an offset antenna configuration is provided. In particular, as shown in FIG. 9, a first set of radiating antenna elements 130 and a second set of radiating antenna elements 132 are provided. Each of the first and second sets of radiating antenna elements 130 and 132 include orthogonal antenna elements. Specifically, the first set of radiating antenna elements 130 includes orthogonal antenna elements 134 and 136 and the second set of radiating antenna elements 132 includes orthogonal antenna elements 138 and 140. The first set of radiating antenna elements 130 and the second set of radiating antenna elements 132 are rotated relative to each other. For example, in one embodiment, the first set of radiating antenna elements 130 and the second set of radiating antenna elements 132 are offset forty-five degrees from each other. However, the offset angle may be varied between zero degrees and 180 degrees.

Similar to the dual port antenna 80 shown in FIGS. 7 and 8, each antenna element is connected to a separate port. For example, orthogonal antenna elements 134 and 136 may be the first side 110 and the second side of the two-dimensional resonator 108 (all shown in FIGS. 7 and 8) with the first side 110 connected to the first port 100 and the second side 112 connected to the second port 102. Additionally, the orthogonal antenna elements 138 and 140 may be connected to the third and fourth ports (not shown) in a similar manner.

The dual port antenna 80 shown in FIG. 9 also may be modified. For example, similar to the antenna 80 shown in FIG. 8, a switch 120 may be included to switch between the first and second sets of radiating antenna elements 130 and 132. Multiplexing operation in time also again may be provided.

Thus, various embodiments of the invention provide an RFID reader with a dual port antenna having orthogonal polarization planes. This orthogonal configuration provides isolation between transmission and receptions that can increase performance, such as, for example, RFID tag read range. Further, the switching operation of various embodiments increases the likelihood that passive RFID tags oriented in different directions can receive sufficient power to provide power-up functionality. Additionally, in the case of randomly oriented tags, the link can be receiver sensitivity limited due to the orientation of the RFID tags. By switching between polarization planes, the probability of reading these RFID tags is increased.

It should be noted that various embodiment may be configured to operate on different frequency bands or in different frequency ranges. For example, the various embodiments may be configured to operate on different RFID frequencies, including, for example, a low-frequency band between 125 KHz to 134 KHz, a mid-frequency of about 13.56 MHz and/or high frequency bands between 850 MHz to 950 MHz and 2.4 GHz to 2.5 GHz. However, the operation of the various embodiments is not limited to these frequencies and the various components may be modified to operate on lower and higher frequencies (e.g., on frequency bands allocated for particular applications or communications).

The various embodiments or components, for example, the RFID system and components therein, or the RFID reader and the components therein, may be implemented as part of one or more computer systems, which may be separate from or integrated with others system. The computer system may include a computer, an input device, a display unit and an interface, for example, for accessing the Internet. The computer may include a microprocessor. The microprocessor may be connected to a communication bus. The computer may also include a memory. The memory may include Random Access Memory (RAM) and Read Only Memory (ROM). The computer system further may include a storage device, which may be a hard disk drive or a removable storage drive such as a floppy disk drive, optical disk drive, and the like. The storage device may also be other similar means for loading computer programs or other instructions into the computer system.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer system executes a set of instructions that are stored in one or more storage elements, in order to process input data. The storage elements may also store data or other information as desired or needed. The storage element may be in the form of an information source or a physical memory element within the processing machine.

The set of instructions may include various commands that instruct the computer as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

While the invention has been described in terms of various specific embodiments, those skilled in the art will recognize that the invention can be practiced with modification within the spirit and scope of the claims.

What is claimed is:

1. An antenna for a radio frequency identification (RFID) system, the antenna comprising:
a first port configured to provide RFID communication in a first polarization plane; and
a second port configured to provide RFID communication in a second polarization plane, the first polarization plane orthogonal to the second polarization plane.

2. An antenna in accordance with claim 1 wherein the first polarization plane comprises horizontal polarization and the second polarization plane comprises vertical polarization.

3. An antenna in accordance with claim 1 wherein the first and second ports are configured to connect to at least one of an RFID transmitter and an RFID receiver of an RFID reader.

4. An antenna in accordance with claim 1 wherein the RFID communication comprises communication with at least one of a passive RFID tag and an active RFID tag.

5. An antenna in accordance with claim 1 wherein the first polarization plane and the second polarization plane define a linear cross-polarization.

6. An antenna in accordance with claim 1 wherein the first port and the second port are formed as part of one of a patch type antenna structure and a dipole antenna structure.

7. An antenna in accordance with claim 1 further comprising a two-dimensional resonator with a first side of the two-dimensional resonator connected to the first port and a second side of the two-dimensional resonator connected to the second port.

8. An antenna in accordance with claim 1 wherein the first and second ports are configured to be switched to each provide a transmit operation and a receive operation.

9. An antenna in accordance with claim 1 further comprising a first set of radiating antenna elements.

10. An antenna in accordance with claim 9 wherein the first set of radiating antenna elements comprises orthogonal antenna elements.

11. An antenna in accordance with claim 9 further comprising a second set of radiating antenna elements offset from the first set of radiating antenna elements.

12. An antenna in accordance with claim 11 wherein the second set of radiating antenna elements comprises orthogonal antenna elements.

13. An antenna in accordance with claim 11 wherein the first set of radiating antenna elements are offset from the second set of radiating antenna elements by an angle of about forty-five degrees.

14. An antenna in accordance with claim 11 further comprising a third port and a fourth port and wherein a first antenna element of the second set of radiating antenna elements is connected to the third port and a second antenna element of the second set of radiating antenna elements is connected to the fourth port.

15. A radio frequency identification (RFID) reader comprising:
a transmitting portion configured to transmit RFID signals;
a receiving portion configured to received RFID signals from at least one RFID tag; and
a dual port polarized antenna configured having orthogonal polarization and configured to be connected to the transmitting portion and the receiving portion.

16. An RFID reader in accordance with claim 15 wherein the dual port polarized antenna comprises a patch type antenna having a first set of orthogonal radiating antenna elements.

17. An RFID reader in accordance with claim 16 wherein the dual port polarized antenna comprises a second set of orthogonal radiating antenna elements offset by an angle from the first set of orthogonal radiating antenna elements.

18. An RFID reader in accordance with claim 15 further comprising a switch configured to switch connection of at least one of the transmitting portion and the receiving portion between a first port and a second port of the dual port polarized antenna.

19. An RFID reader in accordance with claim 15 further comprising a handheld housing having the transmitting portion, receiving portion and dual port polarized antenna therein.

20. A method for communicating in a radio frequency identification (RFID) system, the method comprising:
transmitting an RFID signal in a first polarization plane; and
receiving an RFID signal from an RFID tag in a second polarization plane, the first polarization plane orthogonal to the second polarization plane.
